(19) United States
(12) Patent Application Publication
(10) Pub. No.: US 2023/0097569 A1
(43) Pub. Date: Mar. 30, 2023

(54) ANTIBACTERIAL MODIFIED POLYURETHANE RESIN

(71) Applicants: NAN YA PLASTICS CORPORATION, TAIPEI (TW); CHAIN CHEMICAL CO., LTD., Kaohsiung City (TW)

(72) Inventors: TE-CHAO LIAO, TAIPEI (TW); Pao-Tsao Su, Kaohsiung City (TW); SEN-HUANG HSU, TAIPEI (TW); CHIA-LUNG TSAI, TAIPEI (TW)

(21) Appl. No.: 17/881,570

(22) Filed: Aug. 4, 2022

(30) Foreign Application Priority Data
Sep. 14, 2021 (TW) 110134130

(51) Int. Cl. C08L 75/04; C08G 18/12; C08G 18/42; C08G 18/48; C08G 18/32; C08G 18/08

(52) U.S. Cl. CPC C08L 75/04; C08G 18/12; C08G 18/0814; C08G 18/3228; C08G 18/4238; C08G 18/4854; C08L 2201/54; C08L 2203/02

(57) ABSTRACT

An antibacterial modified polyurethane resin is provided. The antibacterial modified polyurethane resin includes a polyurethane resin and an antibacterial modifying agent grafted on the polyurethane resin. The antibacterial modifying agent has formula (I) as follows:

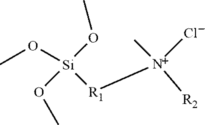

R₁ is a substituent of —(CH2)a—, R₂ is a substituent of —(CH2)bCH3—, a is a positive integer that is greater than or equal to 3, and b is a positive integer that is greater than or equal to 12. The antibacterial modifying agent has three methoxyl groups, at least two of the three methoxyl groups bond to the polyurethane resin through covalent bonds. In the antibacterial modified polyurethane resin, a chloride ion of the antibacterial modifying agent is configured to be ionized, so that a nitrogen atom is configured to be positively charged to attract a bacteria in an environment.

### CROSS-REFERENCE TO RELATED PATENT APPLICATION

This application claims the benefit of priority to Taiwan Patent Application No. 110134130, filed on Sep. 14, 2021. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a polyurethane resin, and more particularly to an antibacterial modified polyurethane resin.

### BACKGROUND OF THE DISCLOSURE

Generally, a conventional polyurethane resin itself does not have an antibacterial ability. Therefore, when the conventional polyurethane resin is used in kitchens, toilets, hospitals and various public places, bacteria can easily grow on the surface of the conventional polyurethane resin, so that the conventional polyurethane resin becomes a source of infection and affects people’s health.

An antibacterial agent (e.g., an organic antibacterial agent, an inorganic antibacterial agent, or a complex antibacterial agent) can be added into the conventional polyurethane resin, after which the conventional polyurethane resin can have a certain degree of antibacterial ability. However, since the antibacterial agent cannot be easily dispersed in the conventional polyurethane resin, the antibacterial ability provided by the conventional polyurethane resin after being added with the antibacterial agent is limited. In addition, since the conventional polyurethane resin containing the antibacterial agent performs sterilization in a chemical manner, issues such as easy degradation, migration, and discoloration, and unsustainable antibacterial ability can occur from the conventional polyurethane resin containing the antibacterial agent. Accordingly, even after the antibacterial agent is added into the conventional polyurethane resin, the antibacterial ability of the conventional polyurethane resin cannot be effectively enhanced.

Therefore, how to enhance the antibacterial ability of the conventional polyurethane resin to improve on the above issues has become one of important topics in the relevant field.

### SUMMARY OF THE DISCLOSURE

In response to the above-referenced technical inadequacies, the present disclosure provides an antibacterial modified polyurethane resin to improve on the issues about a conventional polyurethane resin (i.e., even though the conventional polyurethane resin is added with an antibacterial agent, an antibacterial ability of the conventional polyurethane resin cannot be effectively enhanced).

In one aspect, the present disclosure provides an antibacterial modified polyurethane resin including a polyurethane resin and an antibacterial modifying agent grafted on the polyurethane resin. The antibacterial modifying agent has formula (I) as follows:

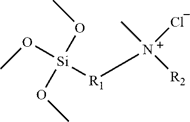

R₁ is a substituent of —(CH₂)ₐ—, R₂ is a substituent of —(CH₂)_{b}CH₃—, a is a positive integer that is greater than or equal to 3, and b is a positive integer that is greater than or equal to 12. The antibacterial modifying agent has three methoxyl groups, at least two of the three methoxyl groups bond to the polyurethane resin through covalent bonds. In the antibacterial modified polyurethane resin, a chloride ion of the antibacterial modifying agent is configured to be ionized, such that a nitrogen atom is positively charged, so as to attract a bacteria in an environment.

In certain embodiments, after antibacterial modified polyurethane resin attracts the bacteria through the nitrogen atom that is positively charged, the antibacterial modified polyurethane resin is configured to penetrate the bacteria through R₂ to perform physical sterilization.

In certain embodiments, the antibacterial modified polyurethane resin further includes water, based on 100 parts by weight of the antibacterial modified polyurethane resin, a content of the polyurethane resin is 12 parts to 50 parts by weight, a content of the antibacterial modifying agent is 1 part to 25 parts by weight, and a content of the water is 35 parts to 65 parts by weight.

In certain embodiments, the antibacterial modified polyurethane resin further includes a chain extender, based on 100 parts by weight of the antibacterial modified polyurethane resin, a content of the chain extender is 0.1 parts to 1 part by weight.

In certain embodiments, a is a positive integer that is greater than or equal to 3 and less than or equal to 5, and b is a positive integer that is greater than or equal to 15 and less than or equal to 17.

In certain embodiments, the antibacterial modifying agent is dimethyloctadecyl[3-(trimethoxysilyl)propyl]ammonium chloride, and antibacterial modifying agent is expressed as formula (II) as follows:

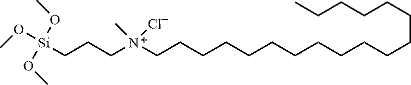

In certain embodiments, the polyurethane resin is a water-soluble polyurethane resin or a water-dispersible polyurethane resin, and the polyurethane resin includes a polymer formed by a polyisocyanate and a polyol.

In certain embodiments, the polyisocyanate is at least one selected from the group consisting of toluene diisocyanate, isophorone diisocyanate, diphenylmethane diisocyanate, dicyclohexylmethane diisocyanate, lysine diisocyanate, p-phenylene diisocyanate, naphthalene diisocyanate, dimethyl biphenyl diisocyanate, cyclohexane diisocyanate, tetramethylxylylene diisocyanate, and 1,3-bis(isocyanatomethyl)cyclohexane, and the polyol is polyester polyol or polyether polyol.

In certain embodiments, the at least two of the three methoxyl groups of the antibacterial modifying agent form into at least two hydroxyl groups, and then the at least two hydroxyl groups covalently bond to at least two isocyanate groups of the polyurethane resin, so that the antibacterial modifying agent is grafted on the polyurethane resin.

In certain embodiments, when staphylococcus aureus or pneumoniae is taken as a test bacteria, an antibacterial activity value [A] of the antibacterial modified polyurethane resin according to a bacteria absorption method of ISO20743:2013 is greater than or equal to 5.5.

Therefore, in the antibacterial modified polyurethane resin provided by the present disclosure, by virtue of “the at least two of the three methoxyl groups bond to the polyurethane resin through covalent bonds” “the chloride ion of the antibacterial modifying agent is configured to be ionized, so that the nitrogen atom is configured to be positively charged to attract a bacteria in an environment,” and “after antibacterial modified polyurethane resin attracts the bacteria through the nitrogen atom that is positively charged, the antibacterial modified polyurethane resin is configured to penetrate the bacteria through R₂ to perform physical sterilization,” the antibacterial modified polyurethane resin can more easily avoid degradation, migration, and discoloration issues, and an antibacterial ability provided by the antibacterial modified polyurethane resin can be maintained for an extended period of time.

These and other aspects of the present disclosure will become apparent from the following description of the embodiment taken in conjunction with the following drawings and their captions, although variations and modifications therein may be affected without departing from the spirit and scope of the novel concepts of the disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

In order to describe a specific numerical range, the term “a certain value to another value” is used in this specification, which should be interpreted as covering any arbitrary value within the specific numerical range and a smaller numerical range defined by any two arbitrary values within the specific numerical range as if the arbitrary values and the smaller numerical range are explicitly listed. In addition, for the sake of brevity, the structural formula of each polymer or functional group in this specification is sometimes expressed in a skeleton formula. Carbon atoms, hydrogen atoms, and carbon-hydrogen bonds in the actual structural formula are omitted. However, when a specific atom or atomic group is clearly depicted in the structural formula, such a structural formula is preferably referred to.

### Antibacterial Modified Polyurethane Resin

The present disclosure provides an antibacterial modified polyurethane resin, and the antibacterial modified polyurethane resin is configured to provide an antibacterial effect without being additionally added with an antibacterial modifying agent. The antibacterial modified polyurethane resin includes a polyurethane resin and an antibacterial modifying agent grafted on the polyurethane resin.

In the present embodiment, the polyurethane resin is a water-soluble polyurethane resin or a water-dispersible polyurethane resin, and the polyurethane resin includes a polymer formed by a polyisocyanate and a polyol, but the present disclosure is not limited thereto.

The antibacterial modifying agent has formula (I) as follows:

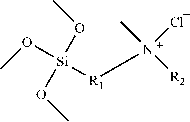

R₁ is a substituent of —(CH₂)ₐ—, R₂ is a substituent of —(CH₂)_{b}CH₃—, a is a positive integer that is greater than or equal to 3, and b is a positive integer that is greater than or equal to 12. Preferably, a is a positive integer that is greater than or equal to 3 and less than or equal to 5, and b is a positive integer that is greater than or equal to 15 and less than or equal to 17. In other words, R₁ can be regarded as a first carbon chain having a carbon number that is greater than or equal to 3 and less than or equal to 5, and R₂ can be regarded as a second carbon chain having a carbon number that is greater than or less than 16 and less than or equal to 18.

The antibacterial modifying agent has three methoxyl groups (-OCH₃), and at least two of the three methoxyl groups bond to the polyurethane resin through covalent bonds. More specifically, the at least two of the three methoxyl groups form into at least two hydroxyl groups in an alkaline environment, and then the at least two hydroxyl groups covalently bond to at least two isocyanate groups (-NCO) of the polyurethane resin, so that the antibacterial modifying agent is configured to be grafted on the polyurethane resin in a covalent bonding manner. Since the antibacterial modifying agent is grafted on the polyurethane resin through the covalent bonding manner, the antibacterial modifying agent can be more evenly dispersed in the antibacterial modified polyurethane resin, and the antibacterial modified polyurethane resin does not easily have degradation, migration, and discoloration issues.

On the other hand, a conventional polyurethane resin may be added with an antibacterial agent, but the antibacterial agent does not covalently bond to the conventional polyurethane resin. Therefore, after the conventional polyurethane resin is added with the antibacterial agent, the conventional polyurethane resin may have degradation, migration, and discoloration issues since the antibacterial agent is not thoroughly dispersed in the conventional polyurethane resin, and an antibacterial ability of the conventional polyurethane resin cannot satisfy application requirements. In addition, an appropriate comparison cannot be made between any polyurethane resin or modified polyurethane resin added with an antibacterial agent but having no covalent bonds with the antibacterial agent, and the antibacterial modified agent of the present disclosure.

A mechanism in which the antibacterial modified polyurethane resin of the present disclosure performs a physical sterilization is substantially described as follows. The antibacterial modified polyurethane resin can attract a bacteria through a positively charged atom, and antibacterial modified polyurethane resin can then penetrate the bacteria that is attracted. More specifically, in the antibacterial modified polyurethane resin, a chloride ion of the antibacterial modifying agent can be ionized, so that a nitrogen atom can be positively charged and can attract the bacteria in the environment. After the antibacterial modified polyurethane resin attracts the bacteria through the nitrogen atom, the antibacterial modified polyurethane resin can penetrate the bacteria through R₂ (i.e., the second carbon chain) to perform the physical sterilization. Since R₂ (i.e., the second carbon chain) is required to be bended to penetrate the bacteria, the carbon number of R₂ cannot be less than 13 (i.e., b needs to be a positive integer that is greater than or equal to 12), and R₂ is not suitable to include other substituent having a large molecular weight to prevent R₂ from being unable to penetrate the bacteria due to steric hindrance. In addition, the carbon number included by R₁ is greater than or equal to 3, so that substituents at two sides of R₁ can play their respective roles.

It is worth mentioning that, the antibacterial modified polyurethane resin of the present disclosure mainly performs sterilization in a physical manner. Preferably, the antibacterial modified polyurethane resin can perform sterilization only in the physical manner and does not perform sterilization in any chemical manner, but the present disclosure is not limited thereto. In addition, since the antibacterial modified polyurethane resin of the present disclosure performs sterilization in the physical manner, compared to the conventional polyurethane resin that is added with antibacterial agent and performs sterilization in the chemical manner, an antibacterial effect provided by the antibacterial modified polyurethane resin of the present disclosure can be maintained for a longer period of time.

In the present embodiment, the antibacterial modified polyurethane can further include water and a chain extender. Based on 100 parts by weight of the antibacterial modified polyurethane resin, a content of the polyurethane resin is 12 parts to 50 parts by weight, a content of the antibacterial modifying agent is 1 part to 25 parts by weight, a content of the water is 35 parts to 65 parts by weight, and a content of the chain extender is 0.1 parts to 1 part by weight. The chain extender can be low molecular weight polyamine having a number average molecular weight that is less than 500, and the chain extender can be ethylene diamine, hexamethylene diamine, xylene diamine, isophorone diamine, diethylenetriamine, or N-aminoethyl-N-ethanolamine.

Preferably, the content of the polyurethane resin is 17 parts to 45 parts by weight, the content of the antibacterial modifying agent is 1 part to 23 parts by weight, and the content of the water is 35 parts to 60 parts by weight. More preferably, the content of the polyurethane resin is 17 parts to 40 parts by weight, the content of the antibacterial modifying agent is 1 part to 15 parts by weight, and the content of the water is 35 parts to 60 parts by weight.

In the present embodiment, the antibacterial modifying agent is dimethyloctadecyl[3-(trimethoxysilyl)propyl]ammonium chloride, and antibacterial modifying agent is expressed as formula (II) as follows:

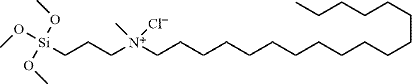

### Method for Manufacturing Antibacterial Modified Polyurethane Resin

A method for manufacturing antibacterial modified polyurethane resin is described as follows. It should be noted that, the antibacterial modified polyurethane resin can be but is not limited to be manufactured by the method for manufacturing antibacterial modified polyurethane resin. The method for manufacturing antibacterial modified polyurethane resin includes a pre-polymer preparing step, a pre-polymer diluting and chain extending step, and a water dispersing step.

The pre-polymer preparing step is implemented as follows. After vacuum dehydrating 10 wt% to 25 wt% of polyol and 1 wt% to 15 wt% of dimethyloctadecyl[3-(trimethoxysilyl)propyl]ammonium chloride, based on 100 by weight of the final antibacterial modified polyurethane resin, the polyol and the dimethyloctadecyl[3-(trimethoxysilyl)propyl]ammonium chloride are added into a reactor including a stirrer, a thermometer and a condenser for oil bath. After a temperature of the oil bath is within a range from 70° C. to 80° C., measured 5 wt% to 12 wt% of polyisocyanate is added into the reactor for a synthesis reaction to form a pre-polymer.

The pre-polymer diluting and chain extending step is implemented as follows. After the pre-polymer reacts for 2 to 3 hours, acetone is added into the reactor for dilution and viscosity reduction. Afterward, a reaction temperature is maintained within a range from 80° C. to 90° C. before NCO% reaches a goal value, and then 1.8 wt% to 3.7 wt% of sodium ethylenediaminoethoxyethanesulfonate is added into the reactor to form into a polymer after continuously reacting for 25 minutes to 40 minutes. The goal value of NCO% can be changed according to practical requirements, and the present disclosure is not limited thereto.

The water dispersing step is implemented as follows. After a temperature of the polymer manufactured in the pre-polymer diluting and chain extending step is reduced to a room temperature, 35 wt% to 55 wt% of deionized water is added under a high-speed shear force of 500 rpm, 0.1 wt% to 0.5 wt% of chain extender is added to carry out a chain extending reaction for about 30 minutes, and then the acetone is removed in a vacuum state to obtain the antibacterial modified polyurethane resin.

In the present embodiment, the polyisocyanate is at least one selected from the group consisting of toluene diisocyanate, isophorone diisocyanate, diphenylmethane diisocyanate, dicyclohexylmethane diisocyanate, lysine diisocyanate, p-phenylene diisocyanate, naphthalene diisocyanate, dimethyl biphenyl diisocyanate, cyclohexane diisocyanate, tetramethylxylylene diisocyanate, and 1,3-bis(isocyanatomethyl)cyclohexane.

In the present embodiment, the polyol can be polyester polyol or polyether polyol. The polyester polyol can be condensed by low molecular glycol and dicarboxylic acid. The low molecular glycol is at least one selected from the group consisting of ethylene glycol, 1,3-propanediol, 1,4-butanediol and 1,6-hexanediol, and the dicarboxylic acid is at least one selected from the group consisting of succinic acid, glutaric acid, adipic acid, pimelic acid, softwood acid, azelaic acid, and sebacic acid. The polyether polyol is tetramethylene ether glycol or polypropylene glycol.

### Test Method and Result of Antibacterial Modified Polyurethane Resin

A test method of the antibacterial modified polyurethane resin is described in essence as follows. Firstly, a textile is impregnated in the antibacterial modified polyurethane resin, and then the textile is dried. A diluted mixed plate culture method is performed to the textile to obtain a test sample. A culture time period is 18 hours, and a test bacteria including 0.05 wt% of a surfactant is used. A standard cotton is inoculated with the test bacteria to obtain a comparison sample. A concentration of the test bacteria is 1.2x10⁵ (CFU/ml).

Relevant test results for when staphylococcus aureus is taken as the test bacteria are shown in the following Table 1 and Table 2, and relevant test results for when pneumoniae is taken as the test bacteria is as the following Table 3 and Table 4. An antibacterial activity value [A] satisfies the equation of antibacterial activity value [A] = (logCₜ-logC₀)-( logTₜ-logT₀). When logC₀ is greater than logT₀, logT₀ is replaced by logC₀. 2 ≤ antibacterial activity value [A] ≤ 3 means enough antibacterial effect. 3 ≤ antibacterial activity value [A] means strong antibacterial effect. The following tests are performed by Osaka Microbiology Laboratory.

TABLE 1

Relevant test result of standard sample when staphylococcus aureus is taken as the test bacteria

| | quantity of bacteria | | proliferation value [F] |
|---|---|---|---|
| standard sample | logC₀ | 4.43 | 2.8 |
| | logCₜ | 7.18 | |

TABLE 2

Relevant test result of test sample when staphylococcus aureus is taken as the test bacteria

| | quantity of bacteria | | antibacterial activity value [A] |
|---|---|---|---|
| test sample | logC₀ | 1.30 | 5.9 |
| | logCₜ | 1.30 | |

TABLE 3

Relevant test result of standard sample when pneumoniae is taken as the test bacteria

| | quantity of bacteria | | proliferation value [F] |
|---|---|---|---|
| standard sample | logC₀ | 4.40 | 2.9 |
| | logCₜ | 7.28 | |

TABLE 4

Relevant test result of test sample when pneumoniae is taken as the test bacteria

| | quantity of bacteria | | antibacterial activity value [A] |
|---|---|---|---|
| test sample | logC₀ | 4.15 | 6.0 |
| | logCₜ | 1.30 | |

As shown in Table. 1 to Table. 4, no matter whether staphylococcus aureus or pneumoniae is taken as the test bacteria, the antibacterial activity values according to a bacteria absorption method of ISO20743:2013 are not less than 5.5 (the antibacterial activity values [A] are respectively 5.9 and 6.0) and far greater than 3, so that the antibacterial modified polyurethane resin of the present disclosure can provide a strong antibacterial effect.

### Beneficial Effects of the Embodiment

In conclusion, in the antibacterial modified polyurethane resin provided by the present disclosure, by virtue of “the at least two of the three methoxyl groups bond to the polyurethane resin through covalent bonds” “the chloride ion of the antibacterial modifying agent is configured to be ionized, so that the nitrogen atom is configured to be positively charged to attract a bacteria in an environment,” and “after antibacterial modified polyurethane resin attracts the bacteria through the nitrogen atom that is positively charged, the antibacterial modified polyurethane resin is configured to penetrate the bacteria through R₂ to perform physical sterilization,” the antibacterial modified polyurethane resin can more easily avoid degradation, migration, and discoloration issues, and an antibacterial ability provided by the antibacterial modified polyurethane resin can be maintained for an extended period of time.

Further, no matter staphylococcus aureus or pneumoniae is taken as the test bacteria, the antibacterial activity values according to a bacteria absorption method of ISO20743:2013 are not less than 5.5, and the antibacterial modified polyurethane resin of the present disclosure can accordingly provide a strong antibacterial effect.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An antibacterial modified polyurethane resin, comprising:
a polyurethane resin; and
an antibacterial modifying agent grafted on the polyurethane resin;
wherein the antibacterial modifying agent has formula (I) as follows: 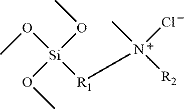
in which R₁ is a substituent of —(CH₂)ₐ—, R₂ is a substituent of —(CH₂)_{b}CH₃—, a is a positive integer that is greater than or equal to 3, and b is a positive integer that is greater than or equal to 12;
wherein the antibacterial modifying agent has three methoxyl groups, at least two of the three methoxyl groups bond to the polyurethane resin through covalent bonds; and
wherein, in the antibacterial modified polyurethane resin, a chloride ion of the antibacterial modifying agent is configured to be ionized such that a nitrogen atom is positively charged, so as to attract a bacteria in an environment.

2. The antibacterial modified polyurethane resin according to claim 1, wherein, after the antibacterial modified polyurethane resin attracts the bacteria through the nitrogen atom that is positively charged, the antibacterial modified polyurethane resin is configured to penetrate the bacteria through R₂ to perform physical sterilization.

3. The antibacterial modified polyurethane resin according to claim 1, further comprising water, wherein based on 100 parts by weight of the antibacterial modified polyurethane resin, a content of the polyurethane resin is 12 parts to 50 parts by weight, a content of the antibacterial modifying agent is 1 part to 25 parts by weight, and a content of the water is 35 parts to 65 parts by weight.

4. The antibacterial modified polyurethane resin according to claim 1, further comprising a chain extender, wherein based on 100 parts by weight of the antibacterial modified polyurethane resin, a content of the chain extender is 0.1 parts to 1 part by weight.

5. The antibacterial modified polyurethane resin according to claim 1, wherein a is a positive integer that is greater than or equal to 3 and less than or equal to 5, and b is a positive integer that is greater than or equal to 15 and less than or equal to 17.

6. The antibacterial modified polyurethane resin according to claim 1, wherein the antibacterial modifying agent is dimethyloctadecyl[3-(trimethoxysilyl)propyl]ammonium chloride, and antibacterial modifying agent is expressed as formula (II) as follows:

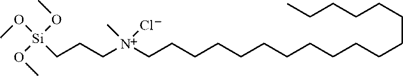

7. The antibacterial modified polyurethane resin according to claim 1, wherein the polyurethane resin is a water-soluble polyurethane resin or a water-dispersible polyurethane resin, and the polyurethane resin includes a polymer formed by a polyisocyanate and a polyol.

8. The antibacterial modified polyurethane resin according to claim 7, wherein the polyisocyanate is at least one selected from the group consisting of toluene diisocyanate, isophorone diisocyanate, diphenylmethane diisocyanate, dicyclohexylmethane diisocyanate, lysine diisocyanate, p-phenylene diisocyanate, naphthalene diisocyanate, dimethyl biphenyl diisocyanate, cyclohexane diisocyanate, tetramethylxylylene diisocyanate, and 1,3-bis(isocyanatomethyl)cyclohexane, and wherein the polyol is polyester polyol or polyether polyol.

9. The antibacterial modified polyurethane resin according to claim 1, wherein the at least two of the three methoxyl groups of the antibacterial modifying agent form into at least two hydroxyl groups, and then the at least two hydroxyl groups covalently bond to at least two isocyanate groups of the polyurethane resin, so that the antibacterial modifying agent is grafted on the polyurethane resin.

10. The antibacterial modified polyurethane resin according to claim 1, wherein, when staphylococcus aureus or pneumoniae is taken as a test bacteria, an antibacterial activity value [A] of the antibacterial modified polyurethane resin according to a bacteria absorption method of ISO20743:2013 is greater than or equal to 5.5.
